(19) United States
(12) Patent Application Publication
(10) Pub. No.: US 2021/0046481 A1
(43) Pub. Date: Feb. 18, 2021

(54) Microfluidic Device

(71) Applicant: Robert Bosch GmbH, Stuttgart (DE)

(72) Inventor: Tino Frank, Luzern (CH)

(21) Appl. No.: 16/976,700

(22) PCT Filed: Feb. 19, 2019
(86) PCT No.: PCT/EP2019/054084

§ 371 Date: Aug. 28, 2020

(30) Foreign Application Priority Data
Mar. 1, 2018 (DE) 10 2018 203 047.2

(51) Int. Cl. B01L 3/00

(52) U.S. Cl. CPC B01L 3/502776; B01L 2300/0829; B01L 2300/089; B01L 2300/0867; B01L 2300/0864

(57) ABSTRACT

A microfluidic device includes a chamber, on two sides of which lying opposite each other in a first direction, a respective first distributor is provided in order to produce a laminar flow in the first direction. Each of the first distributors has at least one branching point, at which a channel is divided into at least two channels. The at least one branching point of the first distributor is arranged in such a way that a first connection channel is connected to a plurality of first connection points of the chamber by means of the first distributor.

The invention relates to a microfluidic device.

Microfluidic devices allow the analysis of small sample quantities with a high level of sensitivity, automation, miniaturization and parallelization. Manual processing steps can be avoided by microfluidic systems. Sample analysis is more accurate, more reproducible and less error-prone. Sample analysis is more cost-effective and more rapid.

A very important problem in the case of microfluidic systems is that of moving small sample quantities to specified sites by means of as much automation as possible in order to cause them to react, to analyze them and to execute other further method steps. This is to be done without the need for manual steps as far as possible, so that, firstly, the effort in processing the samples is reduced and, secondly, causes of error that frequently occur as a result of manual steps are minimized.

Proceeding from this, what is to be described is a microfluidic device and a method for operating a microfluidic device that allow an accurate and automated placement of samples and that are very highly usable in the context of automated processing of microfluidic samples.

### DISCLOSURE OF THE INVENTION

What is to be described here is a microfluidic device comprising a chamber in which a first distributor is respectively provided on two sides which are opposite in a first direction for generation of a laminar flow in the first direction, wherein each of the first distributors has respectively at least one branching site at which a channel divides into at least two channels, wherein the at least one branching site of the first distributor is arranged such that a first connection channel is connected to a plurality of first connection points of the chamber via the first distributor.

The microfluidic device serves to generate a very accurate and precise laminar and parallel flow within the chamber. The fluid flow provided at the first connection channel is evenly distributed over the first connection points. Particularly preferably, the first connection points are evenly distributed over the cross-section of the chamber or over the first side and the second side. The branches are designed such that flow differences at the first connection points do not occur. What can be assigned to each first connection point on the first side is an exactly opposite first connection point on the second side.

The flow within the chamber is generated exactly evenly over all first connection points and flows through the chamber in parallel. The flow speed of the flow is set such that the flow conditions are laminar at any time. Vibrations or any other disturbances that can influence the laminar flow are avoided by suitable measures (e.g., an appropriate position of the device) in order to maintain the laminar flow conditions at any time. Preferably, the flow in the chamber is set such that maximum possible disturbances of the flow do not lead to a termination of the laminarity of the flow.

Between the first connection channel and the first connection points, multiple branching points are preferably present in each case. Particularly preferably, the connection channel branches in each branching point into exactly two subchannels. To provide, for example, eight first connection points on one side of the chamber, branching points are preferably present in three levels. There is firstly a first level of branching to two channels, then a second level of branching with two branching points to four connection channels, and subsequently a third branching level with four branching points to the eight connection points mentioned. For 16 first connection points, there are accordingly four branching levels with altogether 15 individual branching points, which are appropriately distributed over the individual branching levels. This kind of branching can ensure that the fluid flow is exactly divided at each of its branching points and that a particularly uniform laminar flow is thus generated within the chamber. The design of branches to two channels can, in particular, be constructed such that the liquid divides exactly evenly into both channels.

The described microfluidic device allows a particular form of parallelization. The very exact laminar flow means that samples can be moved very precisely in the chamber. To this end, a liquid pressure is applied to one of the first connection channels, or a pressure difference is generated between the two first connection channels. Said pressure difference drives the liquid flow in the chamber, which liquid flow runs exactly in parallel in the chamber. When the liquid flow is maintained for a defined time period and at a defined intensity, the sample moves further by a specified distance in an exact manner.

This is a method for moving samples very precisely that can be controlled via liquid pressure. The approach of moving samples using the device drastically differs in its mode of action from, for example, known mechanical robot arms for moving samples. Such known devices for moving samples always require a mechanical system. By means of a microfluidic device for transporting samples, it has hitherto only ever been possible to simultaneously convey all samples in a region not discretely delimited by walls. By means of the described microfluidic device, it is possible to individually control samples which are present in a free-moving state in a space not subdivided by walls or in the chamber described here.

The microfluidic device is particularly advantageous when a second distributor is respectively provided on two sides which are opposite in a second direction different from the first direction for generation of a laminar flow in the second direction, wherein each of the second distributors has respectively at least one branching site at which a channel divides into at least two channels, wherein the at least one branching site of the second distributor is arranged such that a second connection channel is connected to a plurality of second connection points of the chamber via the second distributor.

The details described further above in relation to the structure and the mode of action of the first connection point, of the first connection channel and of the first distributors are correspondingly transferable to second connection points, second connection channels and second distributors.

The arrangement of second connection points of the chamber means that it is possible to move samples in a direction other than that possible via the first connection points.

Particularly preferably, the first direction and the second direction are perpendicular (at an angle of 90°) to one another.

This makes it possible to achieve specific steering of sample movement in one plane using a pressure at the first connection channel and a pressure at the second connection channel. By application of a pressure or a pressure difference to the first connection points, a movement in an X-direction is possible. By a (subsequent) application of a pressure or a pressure difference to the second connection points, a movement of the sample in a Y-direction is, for example, possible.

Particularly preferably, at least one pump which is connected or is connectable to one of the first distributors via a first valve and to one of the second distributors via a second valve is provided.

The pump is preferably configured to generate a defined pressure gradient which (when a valve is open) leads to a defined flow within the chamber.

Both the first connection channels or the first distributors and the second connection channels or the second distributors can then be controlled using only one common pump. Only one pump is then necessary for providing the necessary liquid pressures for the laminar flows in the chamber in two different directions.

The device is additionally advantageous when at least one respective shutoff valve is provided at at least one of the distributors.

By means of a shutoff valve, the liquid flow via the first distributor or via the second distributor can, in each case, be started and stopped very suddenly (especially at a stroke), with the result that the respectively assigned laminar flow likewise starts and stops very suddenly. For this purpose, the shutoff valves are preferably also designed such that they have no valve volumes or no dead volumes, the terms “valve volumes” and “dead volumes” both meaning here volumes within the valves that enter the valve or exit the valve in an undefined manner when the valve is open or closed. Particularly precise steering of the liquid samples is thus possible.

Particularly preferably, the first connection points and the second connection points have, in each case, a distance of between 5 and 100 μm from one another. The first connection points and the second connection points form, in a way, a grid with a grid spacing. The grid spacing is, for example, from 5 μm to 400 μm, preferably μm to 100 μm (depending on the dimensioning of the respective first and second connection points). What is preferably assigned to the grid spacing is a time interval and a liquid pressure, by means of which a sample can be transported from one grid level into a next grid level. For example, operation of the first connection channels/first distributors for X milliseconds then leads to the sample being transported from one grid level into the next grid level. If the first connection channels/first distributors are operated for 5× milliseconds, the sample is further transported by 5 grid levels. Thereafter, the sample can be appropriately transported by means of a pressure difference or a pressure at the second connection channels/second distributors. Preferably, the intended grid spacings in the first direction and in the second direction both correspond to one another. With the aid of such a grid, each position within the chamber is selectable with the accuracy of the grid. A grid of the chamber preferably has in both directions (first direction and second direction, or X-direction and Y-direction) respectively between 4 and 256 grid spacings in the specified range between 5 μm and 400 μm, but preferably at least 8 grid spacings.

Particularly preferably, the distributors and the connection points are, in each case, implemented with the aid of lithography.

Particularly preferably, the distributors and the connection points are implemented with the aid of photolithography and/or silicon lithography. Photolithography and silicon lithography are semiconductor-technology methods which are usually used for producing integrated circuits, but which can also be used for producing microfluidic devices. By means of exposure to light, the image of a photomask is transferred to a light-sensitive photoresist. Thereafter, the sites of the photoresist that were exposed to light are dissolved (alternatively, the dissolution of the sites not exposed to light is also possible if the photoresist cures under light). The result is a lithographic mask which allows further treatment by chemical and physical processes, for instance the introduction of material into the open windows or the etching of indentations under the open windows. This allows the precise production of the distributors and the connection points in a simple manner.

The microfluidic device is additionally advantageous when the chamber comprises a plurality of indentations arranged as an array.

Preferably, the array consists, in accordance with the grid, of 8×8 to 256×256 indentations, particular preference being given to the grid corresponding to a power of two (8, 16, 32, 64 . . . ). This allows the use of particularly effective distributors which each comprise (exclusively) branching with a division into two channels.

The indentations can also be referred to as pots or as sample containers. What is especially meant here by an arrangement as an array is that the indentations are arranged within the chamber with an even distribution in the manner of a two-dimensional grid. Preferably, a grid specified by the first connection points and second connection points corresponds to the grid of the indentations. It is then possible to precisely select the indentations using the grid of the first connection points and the second connection points.

Individual indentations within the chamber or within the array are then accordingly precisely selectable via liquid pressures at the respective connection points. Samples can be exactly transported into the intended indentation by setting of the liquid pressures at the respective connection points for defined time intervals (in accordance with the grid).

What are preferably respectively present at the indentations are positions at which samples can be subjected to defined method steps. For example, an analysis of the samples can take place at each of the indentations. By means of the described method, it is possible to precisely place samples for a multiplicity of parallel analyses.

The microfluidic device is further particularly advantageous when the chamber and the distributors are provided in a (common) silicon section of the microfluidic device.

This means that the chamber and the distributors were preferably produced together in one silicon material with the aid of a lithography method (photolithography and/or silicon lithography). As a result of the joint production in one silicon section, it is possible to achieve an exact harmonization of the chamber and the distributors with one another.

What is also to be described here is an arrangement comprising a microfluidic device as described further above and an optical capture unit, by means of which a position of a sample within the chamber of the microfluidic device is capturable.

By means of such a capture unit, it is possible to determine the position of a sample in an ongoing manner. The time periods and the pressures on the connection points to steer the position of the sample can be accurately controlled with the aid of the information provided by an optical capture unit with respect to the position of the sample.

What is also to be described here is a method for operating a microfluidic device comprising a chamber, comprising the following steps:

a) providing a sample in the chamber,

b1) generating a laminar flow through the chamber in a first direction, so that the sample arrives at a specifiable position in the first direction.

The method is particularly advantageous when it comprises the subsequent method step:

b2) generating a laminar flow through the chamber in a second direction different from the first direction, so that the sample arrives at a specifiable position in the second direction.

It is possible to carry out said method especially with a microfluidic device as described above. However, it is also possible for said method to be carried out with other microfluidic devices, especially with other microfluidic devices. Such (other) microfluidic devices do not have, for example, the described distributors. Instead, such (other) microfluidic devices may also have elements for generating a laminar flow. What is to be described with the method is the basic principle of positioning of samples by means of laminar flows in two directions.

Method step b1) and method step b2) are preferably carried out one after another over time (especially not at the same time). Particularly preferably, the sample is, after method step b1) has been carried out, initially stationary before method step b2) is started. Very particularly preferably, what is carried out (over time) between method steps b1) and b2) is a method step b1a), in which the sample stands for a fixed time interval (e.g., between 1 ms and 5 ms) in order to avoid mutual influencing of method steps b1) and b2).

In the context of the described method, it is also particularly advantageous when a current position of the sample within the chamber is captured by an optical capture unit and wherein the laminar flow is set on the basis of the position of the sample that was captured by the optical capture unit such that the sample arrives in the specifiable position.

The array of indentations as described further above is especially an array of reaction volumes for carrying out sample analyses. Said array is especially designed analogously to a so-called multiwell plate for macroscopic use, which is a customary arrangement for analysis of a large number of samples.

The array allows so-called multiplex approaches of quantitative PCR or partitioning of a sample. The individual indentations within the array or within the chamber each form pots which are independent of one another. Preferably, once the individual samples have arrived in the individual indentations or pots, what can be applied to the samples is an oil layer which brings about a separation of the individual samples from one another. Owing to the oil layer, the fluids within the chamber are no longer fluidically modifiable. Additional reagents into the individual chambers must be supplied before the application of the oil layer. After the application of the oil layer, the chambers are closed.

The size of the individual indentations, and the accuracy with which the grid is provided within the chamber with the presently described device, allows especially the analysis of individual cells (biological cells, for example human, animal or plant cells) in the individual indentations of the chamber. Generally, the individual chambers are filled such that a cell suspension containing many cells is initially charged over the array.

Also possible is the analysis of functionalized beads. Functionalized beads are small polymeric microspheres which are, for example, coated with an antibody or RNA/DNA sequence. What is of interest in such analyses is especially a first deterministic filling of an indentation (corresponding to a well of a the multiwell plate) with one cell, followed by the deterministic filling of the indentation with such a bead.

The interplay between steps b1) and b2) is used to occupy the individual pots or indentations in such an array on an individual basis (specifically with one cell in each case).

One problem which occurs in customary methods for distributing cells over a multiplicity of indentations or pots arranged as an array is that, in this case, there are normally indentations or pots which remain empty and others which exhibit multiple occupation. Said problem occurs because cells have different sizes and pure distribution without accurate steering of the individual positions of individual cells prevents an exact distribution over the individual indentations or pots of the array.

This customary filling mechanism is therefore unsatisfactory. This problem means that material is discarded with the customary filling mechanisms (especially cellular material situated in indentations in which other cells are also already present). Other regions of the array are not actually used. This is especially disadvantageous when such an array is, for example, provided for the analysis of tumor cells. In the case of tumor cells, it may be the case that an individual cell from a large number of sample cells is the critical cell which must be found in order to ascertain the relevant tumor markers.

An essential quality feature of such an analysis is, then, that all cells in a quantity of cells are treated equally. Accordingly, what is highly desirable is a precise deterministic distribution of the individual cells, as is possible with the presently described method by specific steering of each individual samples (cell) into a defined indentation/into a defined pot within the array. This is a considerable advantage of the described method and also of the described microfluidic device.

The microfluidic device and the microfluidic method are based on the particular properties of laminar flow in microfluidic systems. The pumps used by the microfluidic device and in the microfluidic method for generating laminar flow in the chamber are particularly preferably microfluidic peristaltic pumps. Microfluidic peristaltic pumps make it possible to convey liquid particularly uniformly (dependent on the angle of rotation of an eccentric of such pumps). For example, a device in an arrangement with a peristaltic pump can be set such that an angle of rotation of the eccentric of the peristaltic pump (e.g., 1 angular degree) corresponds to a further movement of the sample in the chamber by one grid spacing. Advantages of microfluidic peristaltic pumps are thus utilized by the described device and the described method. Using such peristaltic pumps, it is possible to generate very uniform flows. Peristaltic pumps also have the major advantage for the presently described method and the device that they behave very similarly in both conveying directions (suction and pushing) in an independent manner and are thus very suitable for the control of the described device.

The microfluidic device and the microfluidic method also additionally involve the following detailed advantages:
The filling of the array composed of indentations is no longer a stochastic process.
Each portion/each sample or each cell can be placed in a defined manner. As described, rare cells are thus especially also isolatable with high accuracy.
The method and the device is especially suitable for the analysis of tumor cells, as already described further above, but is also possibly suitable for an analysis of rare stem cells in a particular way.

In many experiments, so-called index sorting is part of the experiment (especially when rare cells are concerned). This involves searching through a cell suspension by means of a flow cytometer. When a positive cell is found, it is sorted for the array and the array is provided with an index. In this connection, a “positive cell” is a cell which satisfies protein expression patterns for a sought cell type. Said index maintains cell identity. Now, it is necessary to convey said cell to a defined site at which an accurate determination can be made as to what results are provided by the investigation of said cell. For this purpose, the precise positioning of samples, as is possible with the presently described device and the described method, is advantageous. The measurement on the individual cells in the array can then be linked to further items of information (especially to cytometer measurement).

In single-cell experiments with RNA, secreted protein or the like, it is likewise necessary to know exactly which investigation is done with which cell, because each cell within the experiment is different and has specific properties fundamental to carrying out the experiment.

The microfluidic device and the method are more particularly elucidated below on the basis of figures. It should be pointed out that the figures and, in particular, proportions depicted in the figures are only schematic. The following are shown:

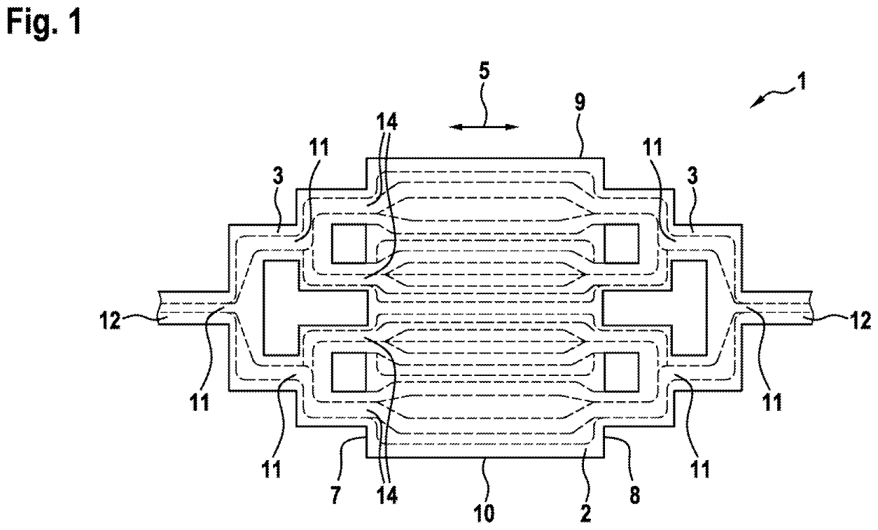

FIG. 1: a described microfluidic device,

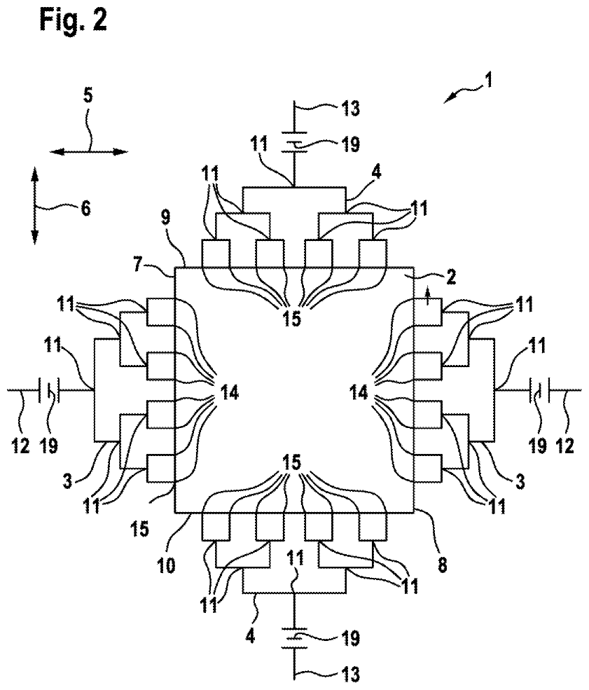

FIG. 2: a further described microfluidic device,

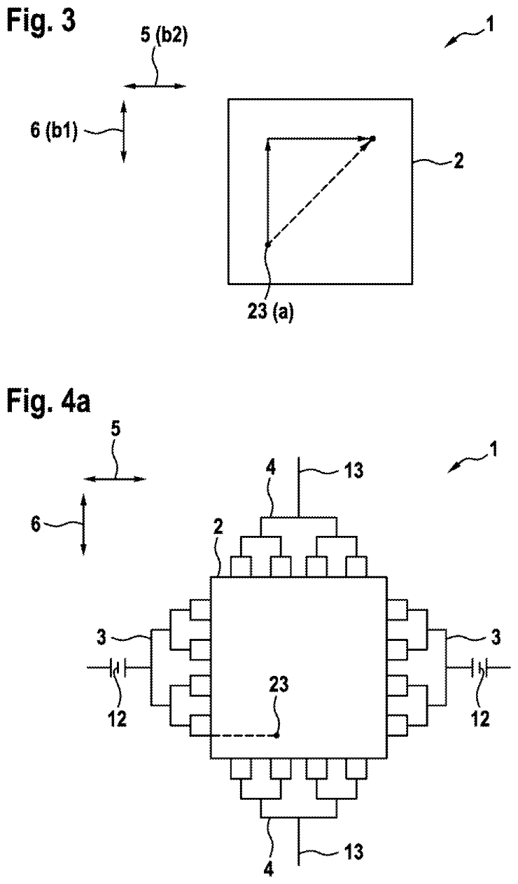

FIG. 3: a flow diagram of a described method,

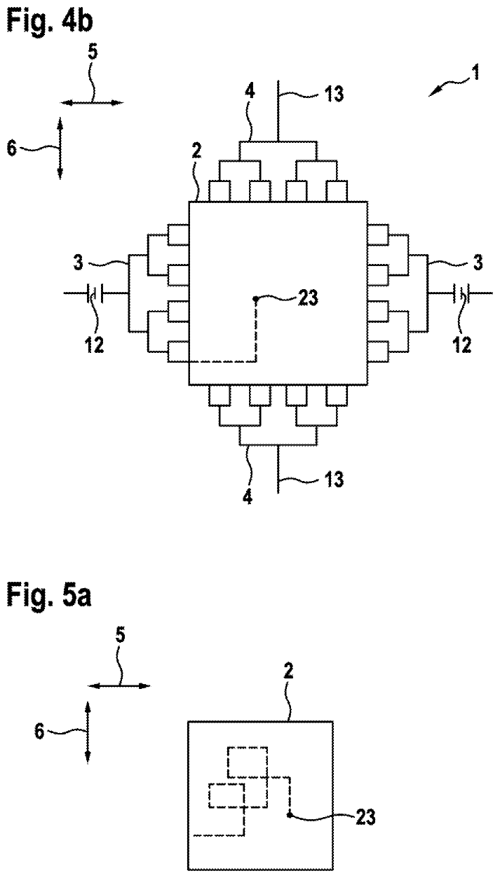

FIG. 4a, 4b: a microfluidic device during various method phases,

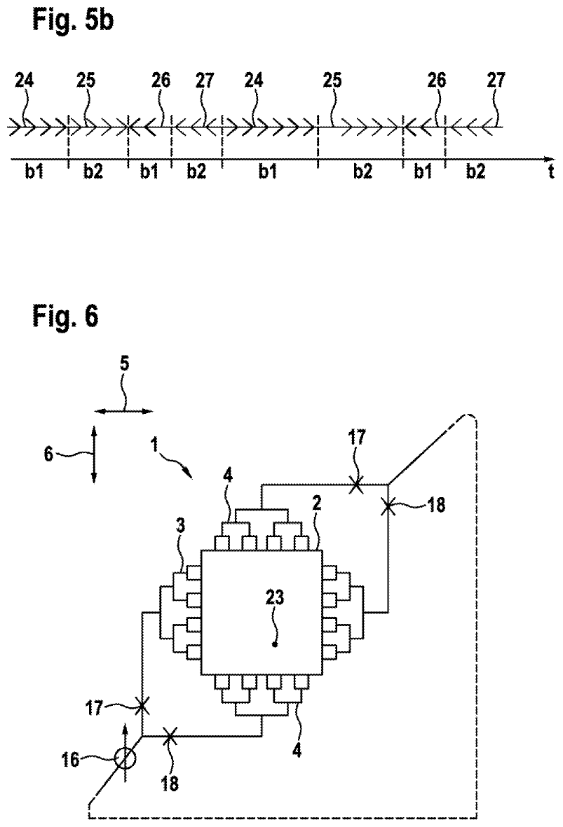

FIG. 5a, 5b: a further flow diagram of the described method,

FIG. 6: one design variant of a described device,

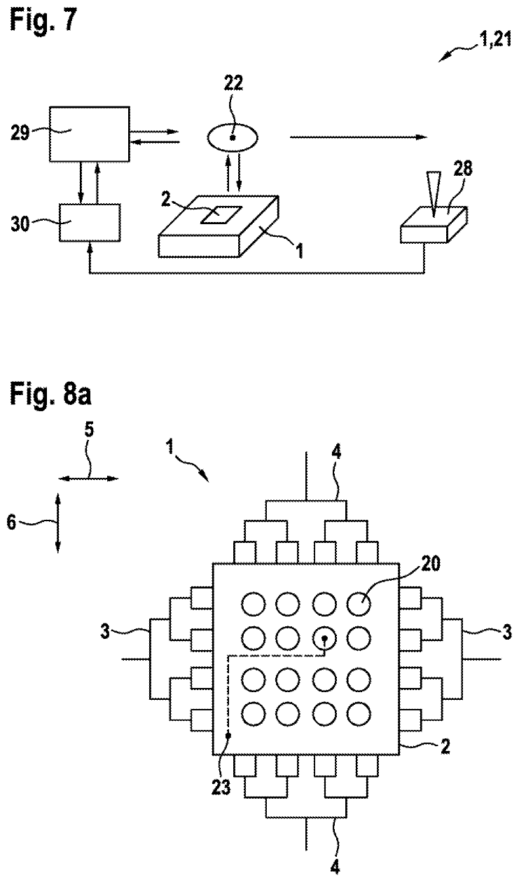

FIG. 7: an arrangement with a described device,

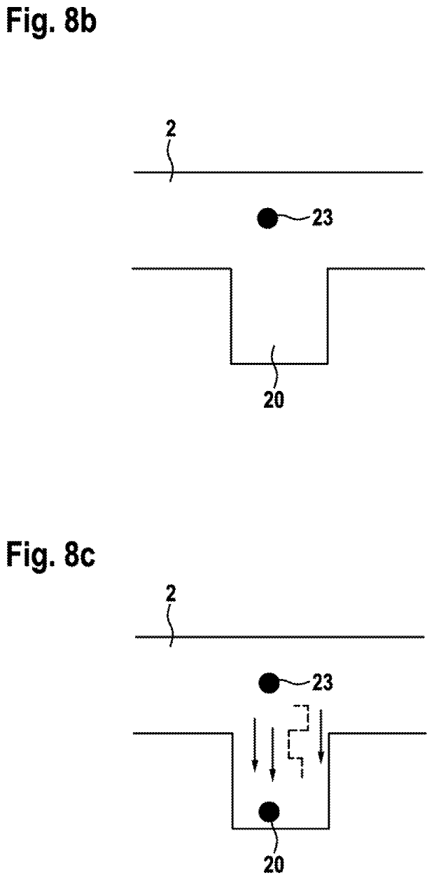

FIG. 8a to c: transport of a sample with a described device,

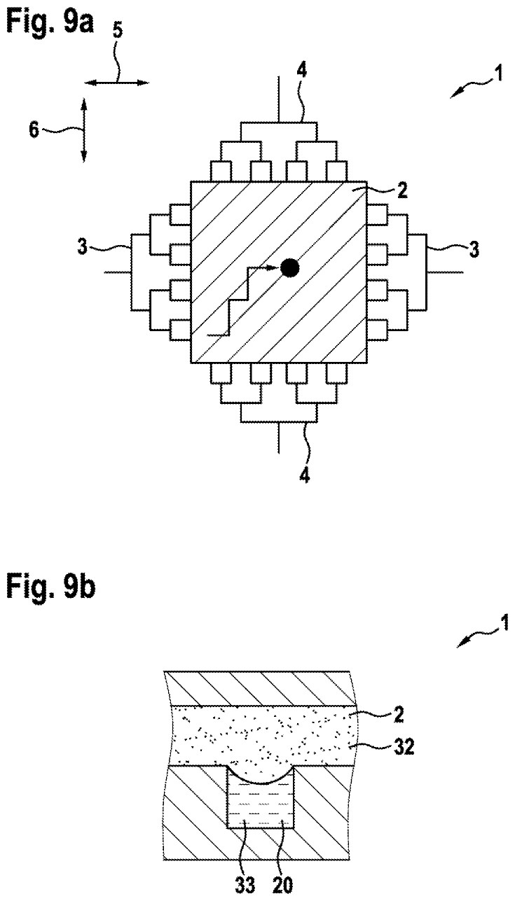

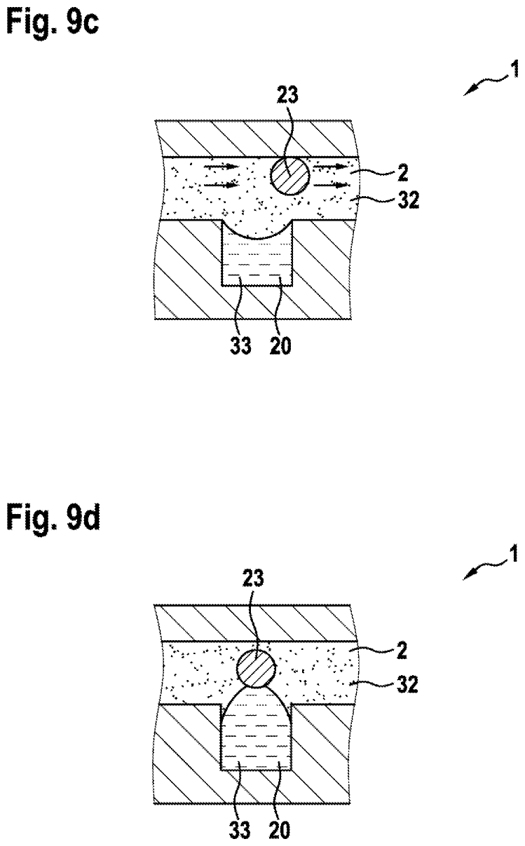

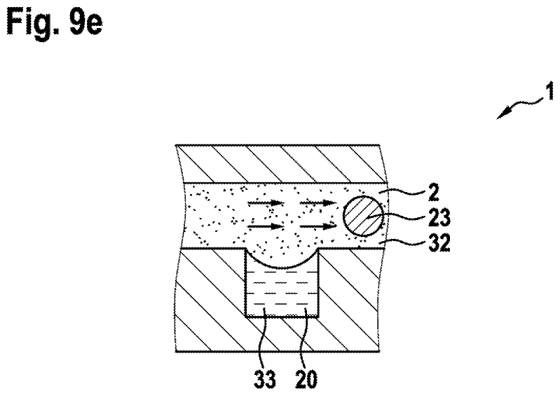

FIG. 9a to e: the operation of a pump in the described method, and

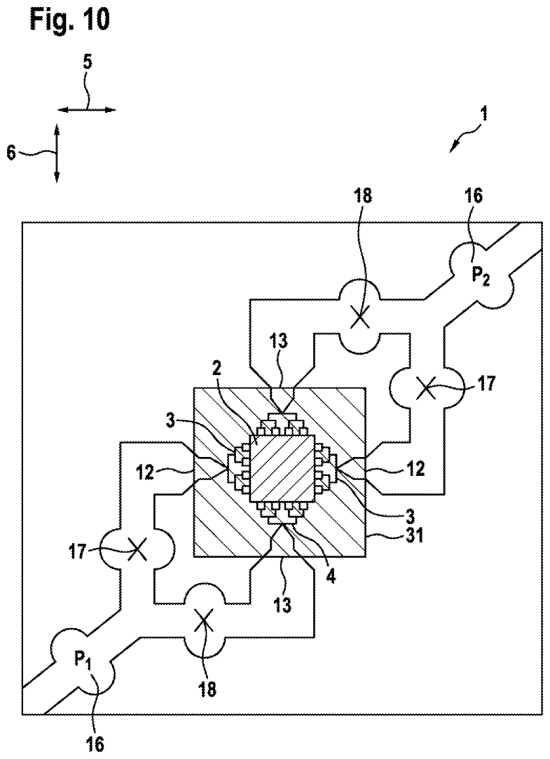

FIG. 10: an arrangement with a described device.

FIG. 1 shows a described microfluidic device 1. What is described here is the basic design of such a microfluidic device 1, in order to show how a particle can be moved in one plane in a controlled manner using the described microfluidic device 1. FIG. 1 is a sketch of one design variant of the described microfluidic device that allows precise positioning of a sample in one direction only.

The microfluidic device 1 has a chamber 2 which has a first direction 5 and two sides which are opposite to one another along the first direction 5 (a first side 7 and a second side 8). Respectively present on the first side 7 and on the second side 8 are first connection points 14, which are evenly distributed over the first side 7 and the second side 8. The first connection points 14 are supplied with fluid via first connection channels 12. Proceeding from the first connection channels 12, the liquid path branches by means of so-called first distributors 3 at branching sites 11 toward the first connection points 14. Preferably, there is a doubling of the number of subchannels at each branching site 11. In this way, multistage first distributors 3 are formed by the branching sites 11. With the aid of the distributors 3 and the first connection points 14, an exactly parallel flow is generated in the chamber 2. By means of said flow, a particle or a sample which is situated in the chamber 2 can be moved very precisely in a first direction 5. In this principle, the laminar flow is especially generated by the first connection points each being divided into subclosures. If the channel dimensions at each branching site 11 remain as equal in size as in the input channel of the particular branching site 11, the flow rate is halved per split and so is the speed of the flow. The split-up channels at each branching site 11 are conducted into the volume of the plane in the chamber 2. The resultant laminar flow is preferably absolutely homogeneous or absolutely parallel in the chamber 2. The first distributors 3 constructed as described are very advantageous therefor. If said first distributors 3 are compared with a simplified variant of a channel enlargement from the first connection channel 12 toward the chamber 2, the first distributors 3 have the advantage that the expansion of the flow is done in an absolutely controlled manner in all planes and no turbulences at all can arise. The flow does not flow freely again until in the chamber 2. However, in the chamber, the flow is already slowed down by the expansion in the first distributors 3 to the extent that it is likewise no longer possible for turbulences to occur. A simple expansion of the flow toward the chamber would accordingly much more likely cause an inhomogeneous speed profile than the described first distributors 3 in the chamber 2. Also important for the microfluidic device 1 is that the first connection channels 12, the branching sites 11 and the first connection points 14 are, in each case, symmetrical on the first side 7 and the second side 8, i.e., exactly opposite to each first connection point 14 on the first side 7 is precisely one first connection point 14 on the second side 8. The liquid flow from the first connection point 12 on the first side 7 toward the first connection point 12 on the second side 8 is first fanned out by the first distributor 3 on the first side 7 and then brought back together by the first distributor 3 on the second side 8. The liquid can flow in the first direction 5 either toward the first side 7 or toward the second side 8. This is possible by a reversal of a conveying direction of a pump connected to the first connection channel 12.

FIG. 2 shows one variant of the microfluidic device 1, which is expanded to a two-dimensional operation compared to the variant of the microfluidic device 1 in FIG. 1. The principle elucidated for one dimension on the basis of FIG. 1 is expanded to two dimensions in FIG. 2.

Besides first connection channels 12 and first connection points 14 on the first side 7 and the second side 8, what are also present as per the design variant in FIG. 2 are second connection channels 13 and second connection points 15 having respectively corresponding second distributors 4 on the third side 9 and the fourth side 10. Particularly preferably (as depicted here too), the chamber 2 is rectangular. Particularly preferably, the chamber 2 is even square. The first connection points 14, the first connection channels 12 and the first distributors 3 are preferably designed just like the second connection points 15, the second connection channels 13 and the second distributors 4. All the above explanations of first connection points 14, first connection channels 12 and first distributors 3 accordingly also apply to second connection channels 13, second connection points 15 and second distributors 4. What is depicted in detail in the chamber 2 in FIG. 2 is how particles in a fluid plane in the chamber 2 can be moved in a controlled manner in a first direction 5 (may also be called X-direction) and in a second direction 6 (may also be called Y-direction). Particularly preferably, a peristaltic pump which can be operated in a forward and backward manner is used for operation of such a microfluidic device 1. It is then possible for particles to be moved to and fro as desired within the plane in the chamber 2. The flow can be used only in one direction at a time. Respectively provided at the connection channels 12 and the second connection channels 13 are shutoff valves 19, by means of which a liquid flow in the chamber 2 can be stopped at a stroke.

A particle or a sample can be introduced into the chamber 2 through any one of the connection channels 12, 13. Once it has arrived in the chamber 2, a particle or a sample within the chamber 2 can then be deterministically (exactly) positioned.

FIG. 3 shows a flow diagram of the described method. Here, the chamber 2 is depicted schematically in the microfluidic device 1. Step A comprises the placement of a sample 23 in the chamber 2. This is followed by executing method steps B1 and B2, by means of which the sample 23 can be positioned in a first direction 5 and in a second direction 6, this being depicted here by arrows within the chamber 2.

FIG. 4a and FIG. 4b show, on the basis of sketches of the microfluidic device 1, how particles or samples are moved. For movement in a first direction 5, valves are closed at second connection channels 13 and at second distributors 4. A liquid flow is in contact with first connection channels 12 and first distributors 3. The sample 23 is accordingly moved in the first direction 5. There is no movement in the second direction 6. This is depicted in FIG. 4a. To move the sample in the second direction 6, first connection channels 12 and first distributors 3, or valves arranged there, are closed. A liquid flow takes place via second distributors 4 and via second connection channels 13. The sample then no longer moves in the first direction 5. There is movement in the second direction 6. FIG. 4b sketches how the sample 23 moves accordingly.

FIG. 5a and FIG. 5b illustrate how various pumping sequences (corresponding to steps B1 and B2) are carried out in the context of the described method. FIG. 5a depicts a sketch of the movement of the sample 23 in the chamber 2 in the first direction 5 and in the second direction 6. FIG. 5b depicts a sequence of individual pump operations as per method steps B1 and B2 (first pumping action 24, second pumping action 25, third pumping action 26 and fourth pumping action 27) over time t (depicted here on a timeline) that corresponds to the movement 23 depicted in FIG. 5a.

FIG. 6 depicts an arrangement 21 comprising a microfluidic device 1. The arrangement 21 depicted in FIG. 6 comprises only one peristaltic pump 16. First distributors 3 or second distributors 4 are respectively arrangeable via first valves 17 and second valves 18 on the chamber 2, so that it is possible, only with one pump via control of the first valves 17 and the second valves 18, to select which forks of a flow path proceeding from the pump 16 can respectively open or close. The sample 23 can accordingly be moved in the first direction 5 or the second direction 6 in the chamber 2.

FIG. 7 shows a microfluidic device 1 in an arrangement 21, with means for further process steps being depicted here as well. The microfluidic device 1 has the chamber 2. The chamber 2 can be monitored by an optical capture unit 22 in order to identify where a (sample not depicted here) is currently situated within the chamber 2. The optical capture unit 22 is part of an optical sensor system. Particles or samples in the chamber 2 can, for example, be identified via fluorescence marker, phase contrast or bright-field recordings, which are carried out using the optical capture unit 22. By means of image evaluation using the optical capture unit 22, for example in a position capturer 29 which is intended therefor and which can comprise a controller, it can then be established whether a particular particle or a particular sample is situated in the chamber and where it is exactly situated. The desired position of a particle or a sample in the chamber 2 is defined. The corresponding X- and Y-components in the first direction and the second direction can then be calculated, and pumping can be carried out accordingly in the respective direction using the (pump not depicted here). The nondepicted pump is part of a flow generator 30 which generates the flows in the chamber 2. For operation of the microfluidic device 1 or the arrangement 21, a control panel 28 is preferably present.

The control panel 28, which comprises a joystick or arrow keys for example, can actively actuate the flow generator 30.

FIG. 8 demonstrates how a sample or a particle is transported into an indentation 20 (may also be called cavity, pot or cell) and then fills the indentation 20. FIG. 8a depicts the microfluidic device 1 comprising the first distributors 3 and the second distributors 4 and the chamber 2, with the indentations 20 being situated in the chamber and arranged in the manner of an array in each case. Also depicted is a sample 23 on its way into one of the indentations 20, the sample being steered on said way with the laminar flows by the first distributors and the second distributor 4. The sample 23 arrives into the respective indentation 20 preferably by gravity. Preferably, the transport speed of the sample 23 in the chamber 2 in the first direction 5 and in the second direction 6 is, however, so great that the sample 23 needs a certain time until it sinks into the intended indentation 20. The sample 23 can thus be successfully transported over indentations 20.

FIG. 8b shows a section of the chamber 2 with the indentation 20, with the sample 23 here being situated above the indentation 20.

FIG. 8c shows how the sample 23 sinks into the indentation 20 from the chamber 2 with the aid of gravity.

FIG. 9a to FIG. 9e shows a method with use of a pump system with a microfluidic device in a two-phase system. Here, the indentations 20 are initially filled with an aqueous phase or water 33 (see FIG. 9b). FIG. 9c depicts the transport of the sample 23 in oil 32, which prevents contamination of the sample 23, in the chamber 2. FIG. 9d depicts how the sample 23 sinks into water 33 in the indentation 20 from the oil 32. FIG. 9e depicts how the sample 23 is transported over the chamber 2 or over the water 33 present in the chamber 2 by the flowing oil 32.

This is shown again by FIG. 9a in the top view of the microfluidic device 1 with the chamber 2, the first direction 5, the second direction 6, the first distributors 3 and the second distributors 4.

FIG. 10 shows one variant of the microfluidic device 1, the aim of which is to explain the production of the microfluidic device 1. What can also be seen here are the first distributors 3, the second distributors 4, the points 16 with the first valves 17 and the second valves 18 and also the chamber 2.

What can be seen is that the chamber with the array of indentations that is situated therein and not depicted here can be situated of a silicon chip, which can be manufactured into a lap and chip cartridge and for example be produced an injection mold. Since very small channel sizes and structures are efficiently producible on a silicon chip, the first distributors 3 and the second distributors 4 are also arranged on the silicon chip. The silicon chip thus forms the chamber 2 and also the first distributors 3 and the second distributors 4. The silicon chip is integrated in a splash-protection housing, on which liquid paths from the pump 16 or from the first valves 17 and the second valves 18 proceed to the first connection channel 12 and the second connection channel 13.

1. A microfluidic device comprising:
a chamber comprising a first side and a second side, which are opposite one another in a first direction; and
a respective first distributor located on each of the first and second sides, the respective first distributors configured to generate a laminar flow in the first direction,
wherein each of the respective first distributors includes at least one first branching site at which a channel divides into at least two channels, and
wherein the at least one first branching site of each respective first distributor is arranged such that a first connection channel is connected to a plurality of first connection points of the chamber via the respective first distributor.

2. The microfluidic device as claimed in claim 1, wherein:
the chamber further comprises a third side and a fourth side, which are opposite one another in a second direction that is different from the first direction;
the microfluidic device further comprises a respective second distributor arranged on each of the third and fourth sides and configured to generate a laminar flow in the second direction;
each of the second distributors has respectively at least one second branching site at which a channel divides into at least two channels; and
the at least one second branching site of each respective second distributor is arranged such that a second connection channel is connected to a plurality of second connection points of the chamber via the respective second distributor.

3. The microfluidic device as claimed in claim 2, wherein the first direction is perpendicular to the second direction.

4. The microfluidic device as claimed in claim 2, further comprising:
at least one pump connected to one of the respective first distributors via a first valve and to one of the respective second distributors via a second valve.

5. The microfluidic device as claimed in claim 2, further comprising:
at least one respective shutoff valve at at least one of the respective first or second distributors.

6. The microfluidic device as claimed in claim 1, wherein the chamber defines a plurality of indentations arranged as an array.

7. The microfluidic device as claimed in claim 1, further comprising:
a silicon section in which at least the chamber and the respective first distributors are arranged.

8. An arrangement comprising:
a microfluidic device comprising:
a chamber comprising a first side and a second side, which are opposite one another in a first direction; and
a respective first distributor located on each of the first and second sides, the respective first distributors configured to generate a laminar flow in the first direction,
wherein each of the respective first distributors includes at least one first branching site at which a channel divides into at least two channels, and
wherein the at least one first branching site of each respective first distributor is arranged such that a first connection channel is connected to a plurality of first connection points of the chamber via the respective first distributor; and
an optical capture unit configured to capture a position of a sample within the chamber of the microfluidic device.

9. A method for operating a microfluidic device having a chamber, comprising:
providing a sample in the chamber,
generating a laminar flow through the chamber in a first direction, so that the sample arrives at a specifiable position in the first direction.

10. The method as claimed in claim 9, further comprising: method step:
generating a laminar flow through the chamber in a second direction different from the first direction, so that the sample arrives at a specifiable position in the second direction.

11. The method as claimed in claim 9, further comprising:
capturing a current position of the sample within the chamber with an optical capture unit; and
setting the laminar flow based on the current position of the sample that was captured by the optical capture unit such that the sample arrives in the specifiable position.
